(19) United States
(12) Patent Application Publication
(10) Pub. No.: US 2010/0309501 A1
(43) Pub. Date: Dec. 9, 2010

(54) DEVICE MANAGEMENT APPARATUS, AND CONTROL METHOD AND STORAGE MEDIUM THEREFOR

(75) Inventor: Tadashi Hagiuda, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/795,214

(22) Filed: Jun. 7, 2010

(30) Foreign Application Priority Data
Jun. 9, 2009 (JP) 2009-138238

(51) Int. Cl. G06F 3/12

(52) U.S. Cl. 358/1.13; 358/1.15

(57) ABSTRACT

A device management apparatus capable of managing a large number of devices, while suppressing a consumed storage area to a minimum, without restricting an amount of information acquired from management object devices and without restricting the number of management object devices. A network device management program which runs on a multi-functional device serving as the device management apparatus searches for network devices connected to a network, acquires basic information from all of searched devices, acquires additional information only from display object devices whose detail information is to be displayed on a device list screen, and separately displays the basic information and the additional information on a display unit.

### BACKGROUND OF THE INVENTION

1. Field of the Invention

The present invention relates to a device management apparatus for managing devices connected to a network, a control method for the apparatus, and a storage medium storing a program for executing the control method.

2. Description of the Related Art

Conventionally, a multi-functional device with plural functions such as a print function and a copy function has software running thereon, and the software is implemented as firmware and generally intended for hardware control. In recent years, with improvement of processing speed of CPU and with reduction in cost of storage device, a multi-functional device has been developed where a software operating environment layer on which various additional software can be installed and activated is provided on a real-time OS for an embedded system of the multi-functional device.

As the additional software, there may be mentioned, for example, software having a function to transmit image data read from an original by a multi-functional device to a desired destination by attaching the image data to e-mail, and software having a function to notify counter information of the multi-functional device or information on consumable supplies (e.g., developer) to a management server via a network.

There is also proposed a technique for a computer network system that includes a printer having a built-in network computer (see, e.g., Japanese Laid-open Patent Publication No. 11-53132). With the proposed technique, the printer downloads from a computer network a data file to be printed and application software corresponding to the data file, and the downloaded application software is activated on the printer to open and convert the data file into a raster image, which is then printed.

It is also known to install and execute a network device management program on a multi-functional device by using a technique such as disclosed in Japanese Laid-open Patent Publication No. 11-53132.

It should be noted that the term “network device management program” used in this specification refers to software that has, for example, a function to search for devices connected to a network, a function to set device information, and a function to monitor the statuses of the devices and send a notification to a manager when detecting an abnormality in any of the devices.

The above-described software running on a multi-functional device largely differs from software running on a general-purpose computer in the following points.

In ordinary operation of a general-purpose computer, desired ones of application software installed in a hard disk are activated. Thus, the general-purpose computer is less demanded to simultaneously activate all the installed software.

On the other hand, a multi-functional device is sometimes demanded to ensure simultaneous operations of a group of built-in standard basic functions. For example, a multi-functional device having a print function and a copy function is demanded to enable a user to utilize the copy function without fail, even while software for creating print data is being operated on the device.

To guarantee the simultaneous operations of plural functions, when application software such as a network device management program is activated on the multi-functional device, an upper limit is generally provided to a storage area available by the application software.

As a result, a problem is posed that the network device management program is required to restrict an amount of information acquired from management object devices or restrict the number of devices managed by the program.

### SUMMARY OF THE INVENTION

The present invention provides a device management apparatus capable of managing a large number of devices, while suppressing a consumed storage area to a minimum, without restricting an amount of information acquired from management object devices and without restricting the number of management object devices, and provides a control method for the device management apparatus and a storage medium storing a program for executing the control method.

According to a first aspect of this invention, there is provided a device management apparatus able to communicate with a plurality of devices via a network, which comprises a first setting unit configured to set a number of display object devices whose information can be displayed on a device list, a search unit configured to search for devices via the network, a first acquisition unit configured to acquire basic information for device identification from the devices searched by the search unit, a second acquisition unit configured to acquire additional information from display object devices, and a display control unit configured to display the device list on a display unit based on the basic information acquired by the first acquisition unit and the additional information acquired by the second acquisition unit.

According to a second aspect of this invention, there is provided a control method for a device management apparatus able to communicate with a plurality of devices via a network, which comprises a first setting step of setting a number of display object devices whose information can be displayed on a device list, a search step of searching for devices via the network, a first acquisition step of acquiring basic information for device identification from the devices searched in the search step, a second acquisition step of acquiring additional information from the display object devices, and a display control step of displaying the device list on a display unit based on the basic information acquired in the first acquisition step and the additional information acquired in the second acquisition step.

According to a third aspect of this invention, there is provided a non-transitory computer-readable storage medium storing a program for causing a computer to execute the control program according to the second aspect of this invention.

With the present invention, basic information is acquired from searched devices and additional information is acquired from display object devices, whereby a large number of devices can be managed, while suppressing a consumed storage area to a minimum, without restricting an amount of information acquired from management object devices and without restricting the number of management object devices.

Further features of the present invention will become apparent from the following description of exemplary embodiments with reference to the attached drawings.

### BRIEF DESCRIPTION OF THE DRAWINGS

FIG. 1 is a schematic view showing an example construction of a network system including a multi-functional device according to a first embodiment of this invention on which runs an embedded network device management program;

FIG. 2 is a block diagram showing the construction of a control unit of the multi-functional device;

FIG. 3 is a block diagram showing the software construction of the network device management program running on the multi-functional device;

FIGS. 4A and 4B are a flowchart showing a process performed by the network device management program to search for devices on a network and display on a device list screen a list of information on searched devices;

FIG. 5 is a flowchart showing the procedures of a process in a case that a page transition occurs on the device list screen;

FIG. 6A is a view showing the construction of a data table created by the network device management program by executing the process shown in FIGS. 4A and 4B;

FIG. 6B is a view showing the construction of a data table created by the process shown in FIG. 5;

FIG. 7 is a view showing a search setting screen displayed by the network device management program;

FIG. 8 is a view showing a device list screen displayed by the network device management program;

FIGS. 9A and 9B is a flowchart showing a process performed by a network device management program running on a multi-functional device according to a second embodiment of this invention to search for devices on a network and display on a device list screen a list of information on the searched devices;

FIG. 10 is a view showing the construction of a data table created by the network device management program; and

FIG. 11 is a view showing a search setting screen displayed by the network device management program.

### DETAILED DESCRIPTION OF THE PREFERRED EMBODIMENTS

The present invention will now be described in detail below with reference to the drawings showing preferred embodiments thereof.

### First Embodiment

In a first embodiment of this invention, there will be described a network system including a multi-functional device (device management apparatus) on which runs a network device management program having a function to search for devices connected to a network and a function to display a list of information on the searched devices. In the following, the hardware construction, software construction, and operation of the network system will be described in this order.

### (Hardware Construction of the System)

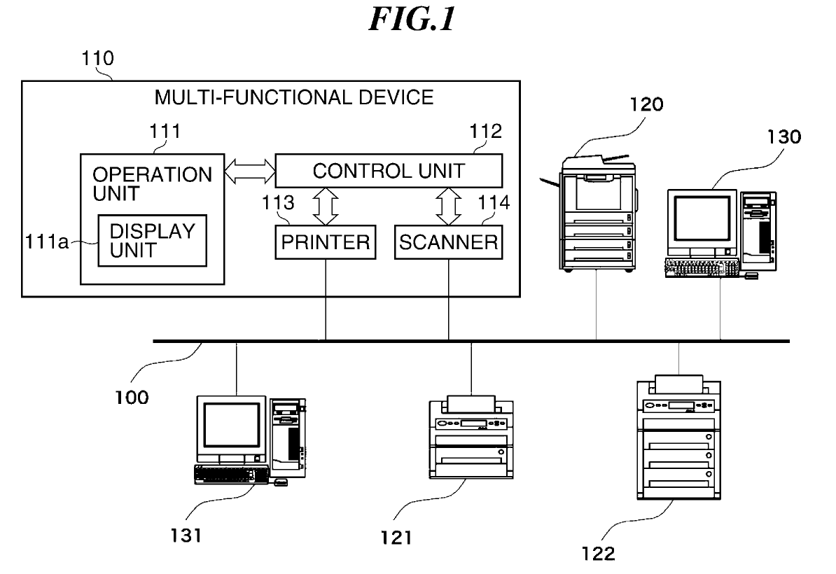

FIG. 1 schematically shows an example construction of the network system.

As shown in FIG. 1, the network system includes a multi-functional device 110, network devices (hereinafter, sometimes abbreviated as the devices) 120-122, and client computers 130, 131, all of which are connected to a network 100. The multi-functional device 110 is an image forming apparatus (multi-function peripheral) on which runs an embedded network device management program (hereinafter, abbreviated as the management program) and which has image forming functions including a print function and a copy function.

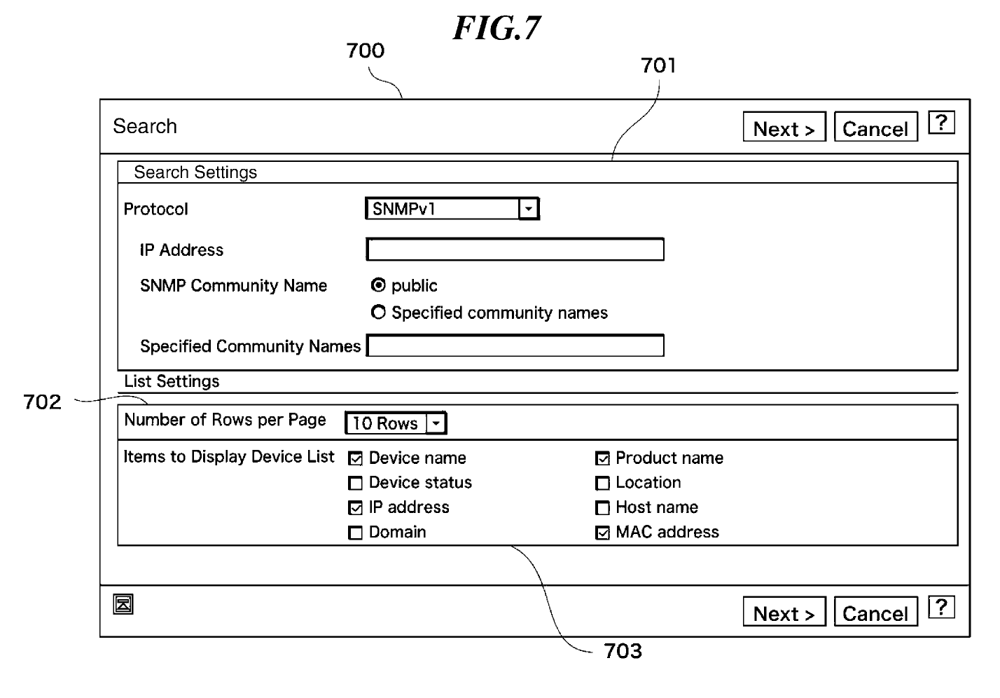

The multi-functional device 110 (device management apparatus) includes an operation unit 111, a control unit 112, a printer 113, and a scanner 114. The operation unit 111 has a control system for enabling a user to make various settings of the multi-functional device 110, and has a display unit 111a for displaying various screens such as those shown in FIGS. 7, 8, and 11. The control unit 112 performs overall control of the multi-functional device 110. The printer 113 is an image output unit for forming an image on a recording sheet. The scanner 114 is an image input unit for reading an image from an original.

The multi-functional device 110 is able to communicate via the network 100 with the devices 120-122, which are management objects, and with the client computers 130, 131. In accordance with a user's operation on the operation unit 111 or a command received from the network 100, the control unit 112 controls the printer 113 and the scanner 114 to execute various processing.

The management program running on the multi-functional device 110 searches for the management object devices 120-122, accepts commands from users of the client computers 130, 131, and performs desired processing.

The network devices 120-122 are each configured as an image forming apparatus that has a single image forming function including only a print function or plural image forming functions including a print function and a copy function. Each of the client computers 130, 131 is able to instruct via the network 100 a desired one or ones of the multi-functional device 110 and the network devices 120-122 to perform a print operation or a copy operation.

### (Hardware Construction of the Multi-Functional Device)

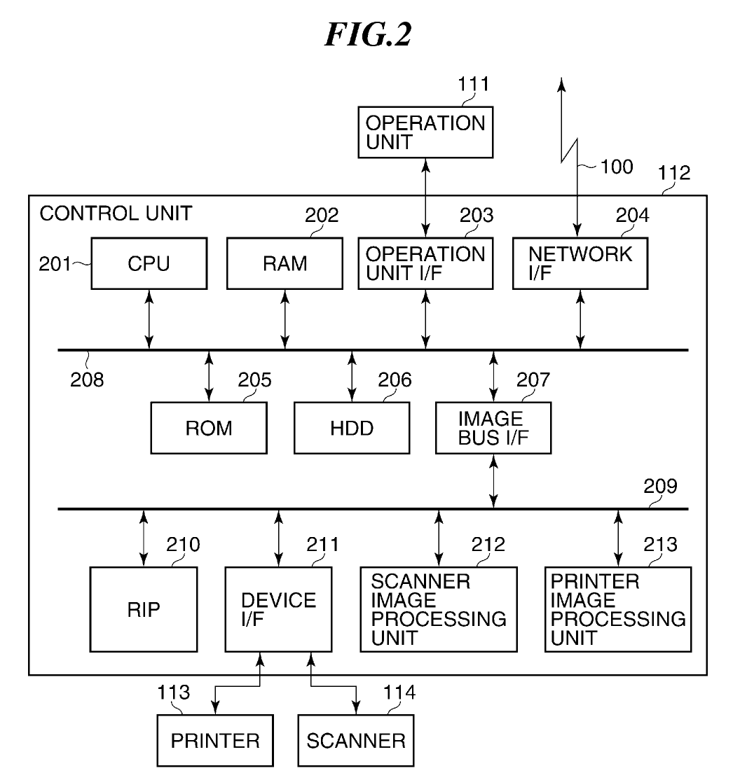

FIG. 2 shows the construction of the control unit 112 of the multi-functional device 110.

As shown in FIG. 2, the control unit 112 includes a CPU 201, a RAM 202, an operation unit interface 203 (hereinafter, the term “interface” will be abbreviated as I/F), a network I/F 204, a ROM 205, a hard disk drive (HDD) 206, and an image bus I/F 207. The control unit 112 further includes a raster image processor (RIP) 210, a device I/F 211, a scanner image processing unit 212, and a printer image processing unit 213.

The CPU 201 is a controller that controls the entire control unit 112. The RAM 202 is a system work memory used by the CPU 201 for its operation and used as an image memory for temporal storage of image data. The ROM 205 is a boot ROM that stores a boot program for the system. The HDD 206 stores system software and image data.

The operation unit I/F 203 provides an interface between the operation unit 111 and the system bus 208, performs display control to output image data that is to be displayed on the display unit 111a of the operation unit 111, and transmits to the CPU 201 control information input by a user via the operation unit 111. The network I/F 204 establishes connection with the network 100, and inputs and outputs information from and to the network 100.

The image bus I/F 207 is a bus bridge for establishing connection between a system bus 208 and an image bus 209 and for converting data structure. The image bus 209 is a serial bus implemented by, e.g., a PCI (peripheral component interconnect) architecture or an IEEE 1394 architecture for transferring image data at high speed.

The RIP 210 decompresses a PDL command received via the network 100 into a bitmap image. The device I/F 211 connects the control unit 112 with the printer 113 and the scanner 114, and performs synchronous/asynchronous conversion of image data. The scanner image processing unit 212 performs correction, modification, and editing on input image data. The printer image processing unit 213 performs correction, resolution conversion, etc., on print output image data according to the performance of the printer 113.

### (Software Construction of the System)

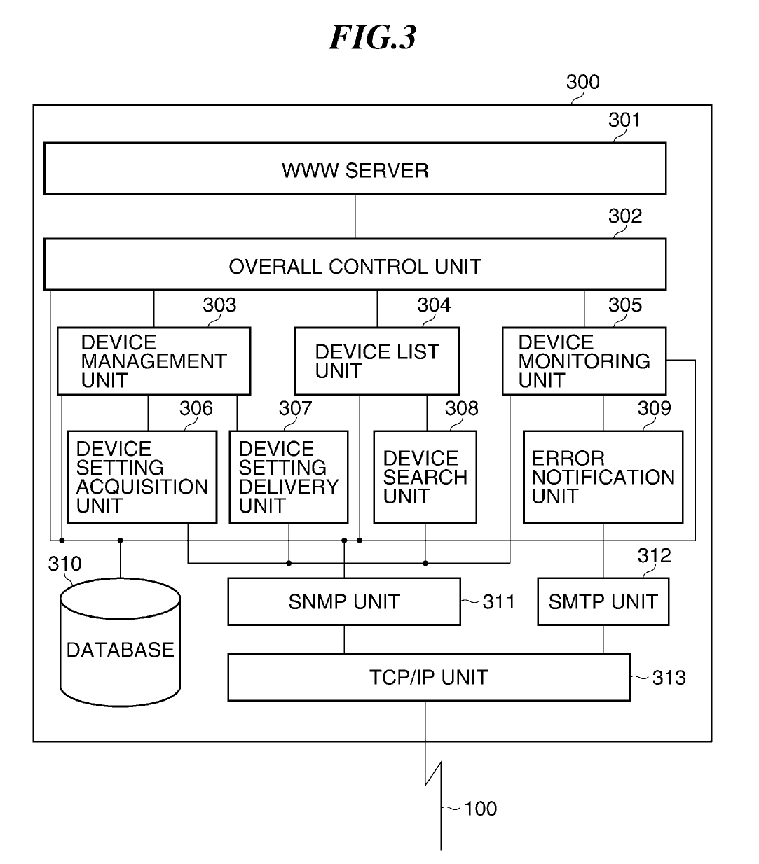

FIG. 3 shows in block diagram the software construction of the management program running on the multi-functional device 110.

Referring to FIG. 3, the management program shown at 300 includes a WWW server 301, an overall control unit 302, a device management unit 303, a device list unit 304, a device monitoring unit 305, a device setting acquisition unit 306, and a device setting delivery unit 307. The management program 300 further includes a device search unit 308, an error notification unit 309, a database unit 310, an SNMP unit 311, an SMTP unit 312, and a TCP/IP unit 313.

In this embodiment, the management program 300 is stored in the HDD 206 and executed by the CPU 201 unless otherwise specified. The management program 300 acquires various management information from the network devices 120-122, which are management objects. In addition, the management program 300 creates HTML (hyper text markup language) data including the acquired management information, and opens the created HTML data to a user via the WWW server 301.

The WWW server 301 operates on the multi-functional device 110. The overall control unit 302 is a function module that communicates with the network devices 120-122 to perform acquisition and setting of information and that controls the device management unit 303, the device list unit 304, and the device monitoring unit 305 to create the HTML data. The device management unit 303 is a function module that controls the device setting acquisition unit 306 and the device setting delivery unit 307 and that communicates with the management object network devices 120-122 to perform acquisition and setting of various management information.

The device setting acquisition unit 306 is a function module that acquires model information, etc. on the management object network devices 120-122 from the database unit 310 and that acquires model-dependent management information from the network devices 120-122 via the SNMP unit 311. The device setting delivery unit 307 is a function module that acquires model information, etc. on the management object network devices 120-122 from the database unit 310 and that delivers model-dependent management information to the multi-functional device via the SNMP unit 311.

The device list unit 304 is a function module that controls the device search unit 308 to search for the network devices 120-122, displays a list of information on devices searched according to procedures described below, and registers required information into the database unit 310. The device search unit 308 is a function module that controls the SNMP unit 311 and searches for the network devices 120-122 by transmitting, e.g., a unicast, broadcast, or multicast search packet to designated addresses.

The device monitoring unit 305 is a function module that acquires device status information from the management object network devices 120-122 at intervals of a predetermined cycle. The device monitoring unit 305 has a function of controlling the error notification unit 309 to notify a user of abnormality information when detecting occurrence of abnormality in any of the network devices 120-122. The error notification unit 309 is a function module that controls the SMTP unit 312 to notify by e-mail a predetermined user of occurrence of abnormality when the device monitoring unit 305 detects abnormality in any of the network devices 120-122.

The database unit 310 stores information on a user of the management program 300 and various information on the management object network devices 120-122.

The SNMP unit 311, which is a function module that performs SNMP (simple network management protocol) control, is used to set management information to the management object network devices 120-122 and to acquire management information from the network devices 120-122.

The SMTP unit 312, which is a function module that performs SMTP (simple mail transfer protocol) control, is used to control the error notification unit 309 to transmit a notification e-mail to the user, if an abnormality occurs in any of the management object network devices 120-122.

The TCP/IP (transmission control protocol/internet protocol) unit 313 is a function module that performs communication control according to a request from the SNMP unit 311 and the SMTP unit 312.

### (Procedures of Screen Display of Device List)

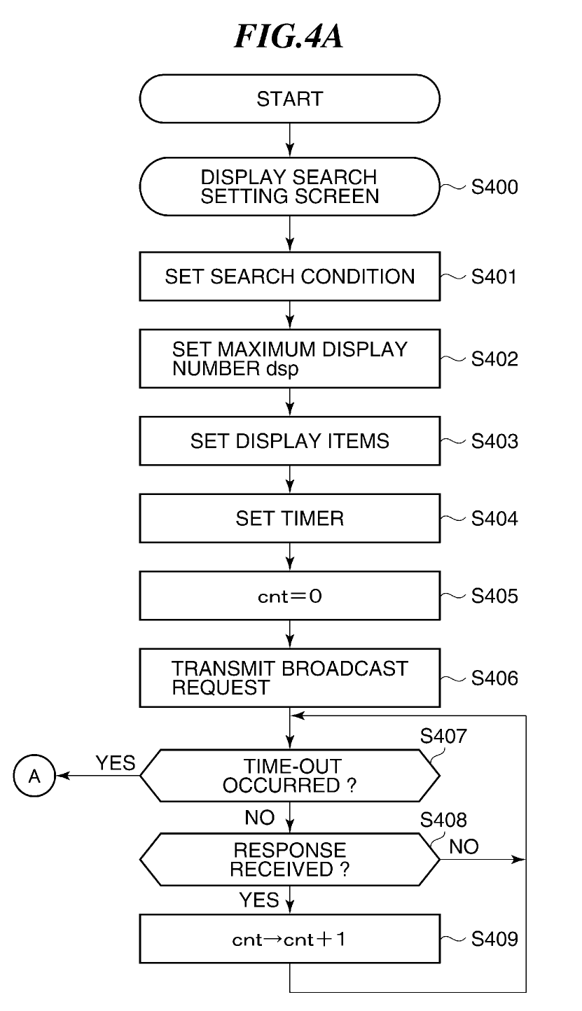

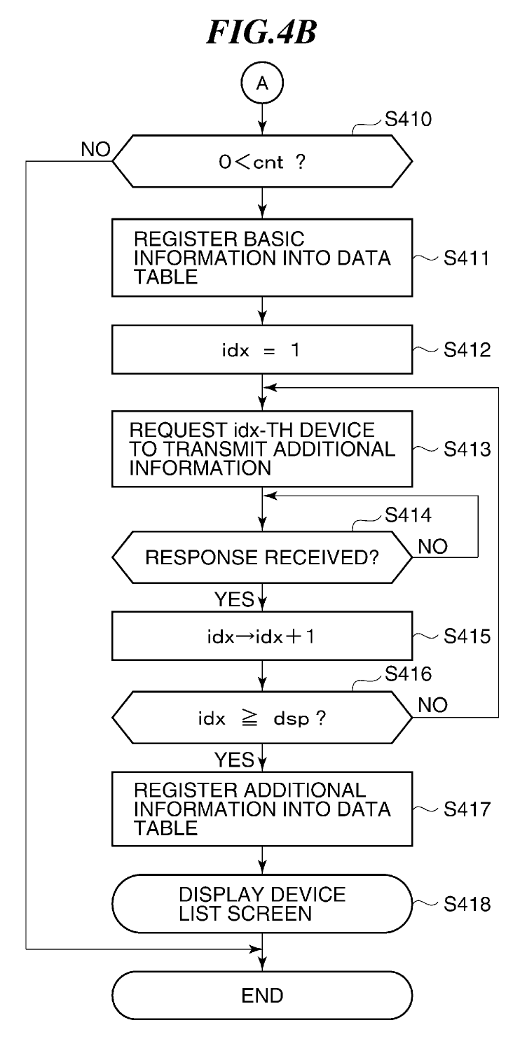

FIGS. 4A and 4B show in flowchart a process performed by the management program 300 to search for devices on the network and to display on a device list screen a list of information on searched devices.

In this process, display on a user interface (UI) and user's input are processed by the device list unit 304, and search of devices connected to the network 100 is processed by the device search 308, the SNMP unit 311, and the TCP/IP unit 313.

Referring to FIGS. 4A and 4B, the management program 300 displays a search setting screen (shown at 700 in FIG. 7) on the display unit 111a of the operation unit 111 (step S400). When a device search condition is designated by the user on the search setting screen 700, the management program 300 sets the designated search condition (step S401 (second setting unit)). Broadcast address, SNMP community name, and the like are set as the search condition since it is assumed in this embodiment that the management program 300 searches for devices by using broadcast search and SNMP protocol.

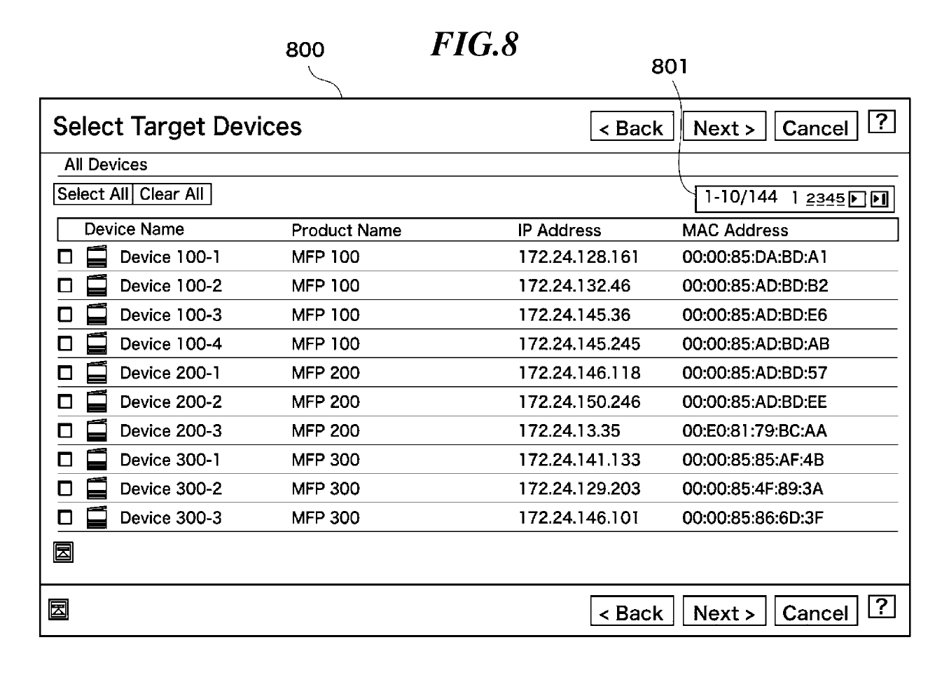

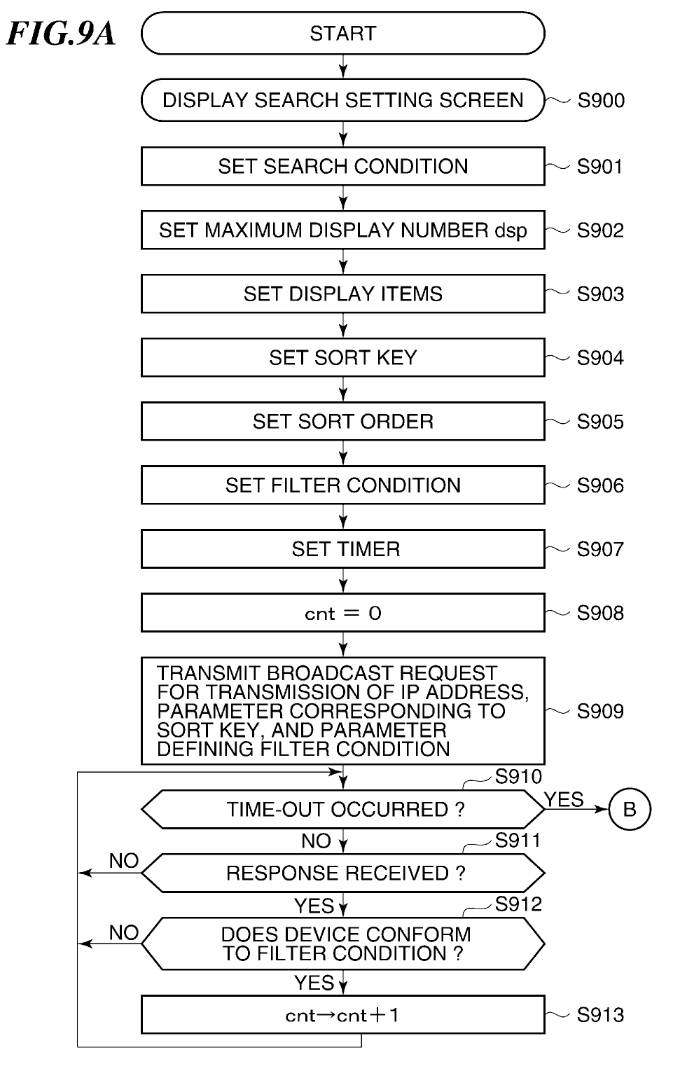

When a maximum display number dsp (i.e., a maximum number of device fields that can be displayed on one page of the device list screen shown at 800 in FIG. 8) is selected by the user on the search setting screen 700, the management program 300 sets the selected maximum display number dsp (step S402 (first setting unit)). Next, when display items to be displayed on the device list screen 800 are selected by the user on the search setting screen 700, the management program 300 sets the selected display items (step S403). In this embodiment, desired ones of device name, product name, device status, location, IP address, host name, domain, and MAC address can be selected as the display items (see, FIG. 7). The device name indicates a user-friendly name of the corresponding device.

In the next step S404, the management program 300 sets a timer for monitoring a device search process to be started in step S406.

The device search process of this embodiment is comprised of two phases. A first phase of the process is to transmit an SNMP broadcast request to acquire IP addresses of devices, which are basic information for device identification. A second phase is to acquire, as additional information, information on the display items selected in step S403 other than the IP addresses. In step S404, a time period for the first phase of the device search process is set to the timer.

In the next step S405, the management program 300 initializes to zero a count value cnt of a counter that represents the number of devices responding to a broadcast request to be transmitted in step S406. Then, in accordance with the search condition set in step S401, the management program 300 starts the device search process for acquisition of the basic information (IP addresses). Specifically, the management program 300 transmits the broadcast request to the devices on the network 100 (step S406 (search unit)), and determines whether the timer set in step S404 has timed out (step S407).

If it is determined that a time-out has not occurred, the management program 300 determines whether it receives a response from any of the devices on the network in response to the broadcast request (step S408). If the management program 300 does not receive a response, the flow returns to step S407. When receiving a response, the management program 300 increments the counter value cnt by one (step S409), and the flow returns to step S407.

If it is determined that a time-out has occurred (YES to step S407), the management program 300 determines whether the counter value cnt representing the number of devices, detected in the device search process for basic information acquisition, is larger than zero (step S410). If it is determined that the number of devices is not larger than zero (i.e., equal to zero), the present process is completed.

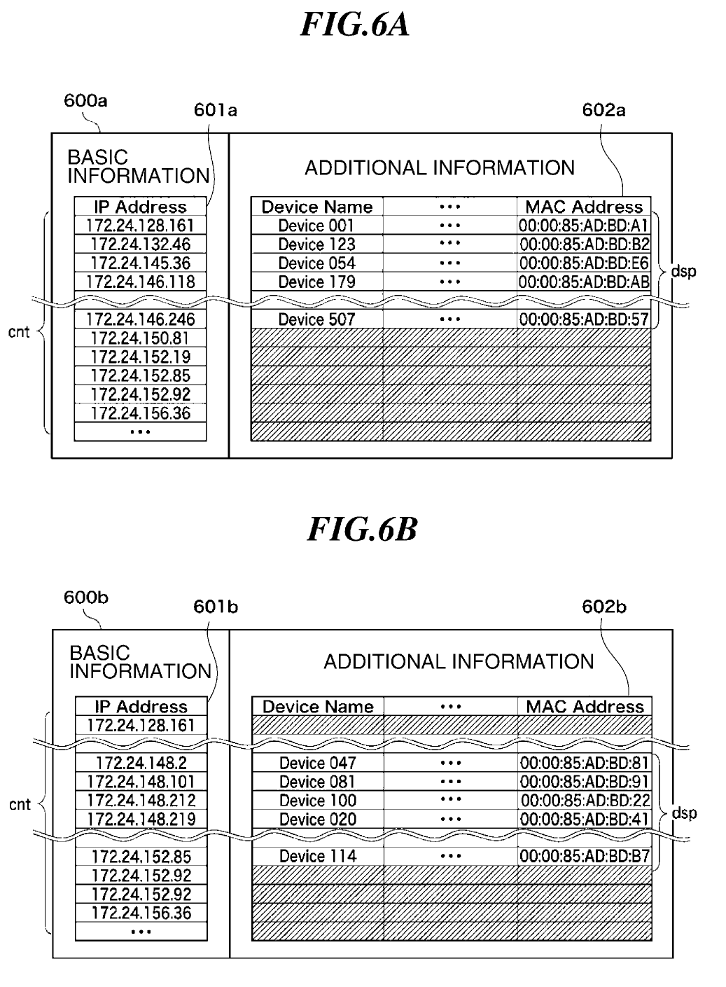

If it is determined in step S410 that the number of devices is larger than zero (i.e., equal to or more than one), the management program 300 registers the basic information acquired in the first phase device search process into a data table (step S411 (first acquisition unit)). The construction of the data table is shown in FIG. 6A. In step S411, a list of basic information shown at 601a in FIG. 6A is created.

Next, the management program 300 initializes, to a value of 1, an index idx representing the device from which additional information is to be acquired (step S412), and transmits to the idx-th device a request for acquisition of additional information (step S413 (second acquisition unit)). The additional information corresponds to the display items selected in step S403, except for the basic information (IP addresses) acquired in the first phase device search process.

Next, the management program 300 determines whether it receives a response from the idx-th device responding to the additional information acquisition request (step S414). When receiving no response from the idx-th device, the management program 300 waits for reception of a response in step S414. When receiving a response from the idx-th device, the management program 300 increments by one the index idx representing the device from which the additional information is to be acquired (step S415).

In the next step S416, the management program 300 determines whether the index idx is equal to or larger than the maximum display number dsp set in step S402. If it is determined that the index idx is not equal to nor larger than the maximum display number dsp, the flow returns to step S413.

If it is determined that the index idx is equal to or larger than the maximum display number dsp, the management program 300 determines that the second phase device search process (i.e., the additional information acquisition process) has been completed, and registers the additional information shown at 602a into the data table in FIG. 6A (step S417). In the next step S418 (display control unit), the management program 300 displays on the operation unit 111 a device list screen (FIG. 8) including information on the first through dsp-th devices based on the data table registered (set) in step S417, whereupon the present process is completed.

### (Procedures Upon Page Transition on the Device List Screen)

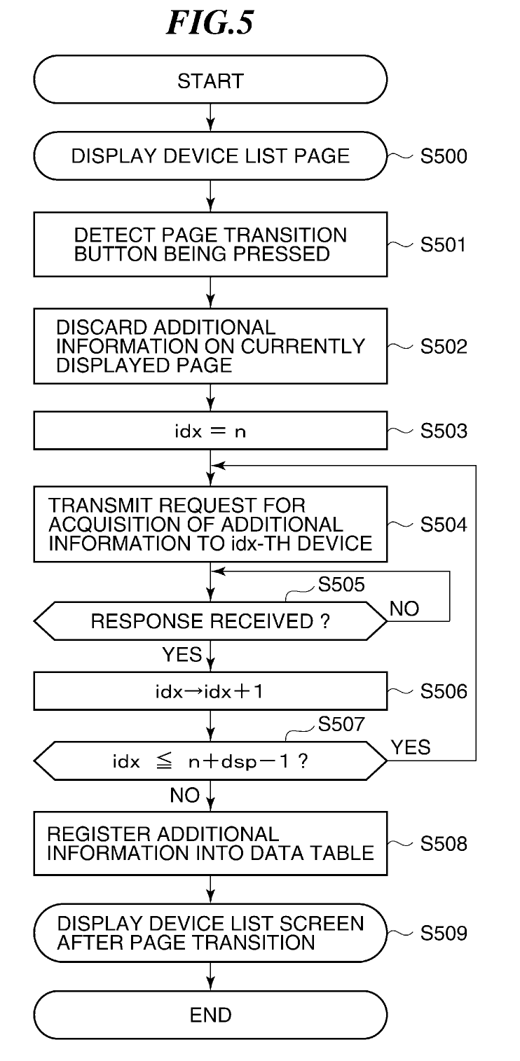

FIG. 5 shows in flowchart the procedures of a process in a case that a page transition occurs on the device list screen displayed by the management program 300.

In this process, display on the user interface (UI) and user's input are processed by the device list unit 304 shown in FIG. 3, and acquisition of additional information from the devices connected to the network 100 is processed by the device search unit 308, the SNMP unit 311, and the TCP/IP unit 313, which are shown in FIG. 3.

In the process shown in FIG. 5, the management program 300 displays an arbitrary page (the first page in this example) of the device list on the device list screen of the operation unit 111 (step S500). When a page transition button (a paging control 801 in FIG. 8) on the device list screen is pressed by the user, the management program 300 detects the page transition button being pressed. Specifically, in step S501, the management program 300 detects a user's screen operation for transition to a page (the second page of the device list in this example) containing information for the maximum display number dsp of devices set in step S402 in FIG. 4A.

In the next step S502 (discard unit), the management program 300 discards additional information on the first to the (n−1)-th devices contained in the currently displayed device list screen (i.e., the first page of the device list). Then, the management program 300 initializes, to a value of n, the index idx representing the device from which the additional information is to be acquired (step S503), and causes the SNMP unit 311 to transmit a request for acquisition of additional information to the idx-th device (initially, the n-th device) (step S504 (third acquisition unit)).

Next, the management program 300 determines whether it receives a response from the idx-th device responding to the additional information acquisition request (step S505). When receiving no response from the idx-th device, the management program 300 waits for reception of a response in step S505. When receiving a response from the idx-th device, the management program 300 increments the index idx by one (step S506).

Next, the management program 300 determines whether the index idx is equal to or less than a value of n+idx−1 representing the last device to be displayed on the device list screen after page transition (step S507). If the answer to step S507 is YES, i.e., if it is determined that the idx-th device is one of the display object devices, the flow returns to step S504.

If the answer to step S507 is NO, the management program 300 determines that the additional information acquisition process has been completed, and registers additional information 602b of the devices into the data table shown in FIG. 6B (step S508). It should be noted that the basic information 601b in FIG. 6B, which is similar to the basic information 601a in FIG. 6A, is created in step S411 in FIG. 4B. Subsequently, the management program 300 displays on the operation unit 111 the device list screen after page transition that includes the additional information on the n-th through (n+idx−1)-th devices (step S509 (display control unit)), whereupon the present process is completed.

### (Construction of Data Table)

FIGS. 6A and 6B each show the construction of a data table created by the management program 300.

In FIG. 6A, reference numeral 600a denotes the data table created by the process shown in FIGS. 4A and 48. Reference numeral 601a denotes a list of the basic information registered in step S411 in FIG. 4B. In this embodiment, each basic information is comprised of IP address. Reference numeral 602a denotes a list of the additional information registered in step S417 in FIG. 4B. In this embodiment, each additional information is comprised of desired ones of device name (user-friendly name), product name, device status, location, host name, network domain to which the device belongs, and MAC address.

In FIG. 63, reference numeral 602b denotes the data table created by the process shown in FIG. 5, 601b denotes a list of the basic information (IP addresses) registered in step S411 in FIGS. 4B, and 602b denotes a list of the additional information registered in step S508 in FIG. 5.

With the management program 300 of this embodiment, the basic information is acquired from all the searched devices, and the additional information is acquired only from the display object devices whose detail information is to be displayed on the device list screen, as shown in FIGS. 6A and 6B.

### (Search Setting Screen)

FIG. 7 shows a search setting screen displayed by the management program 300 in step S400 in FIG. 4A.

Referring to FIG. 7, the search setting screen shown at 700 has a search condition setting field 701 that serves as the setting unit used by the user to set the search condition in step S401. A maximum display number setting field 702 is provided as the setting unit used by the user in step S402 to select the number of device fields (the number of rows) that can be displayed on one page of the device list screen shown in FIG. 8.

A display item selecting filed 703 is provided as a selection unit used by the user in step S403 to select display items to be displayed on the device list screen. In the example shown in FIG. 7, it is possible to select desired display items from among device name, product name, device status, location, IP address, host name, domain, and MAC address.

### (Device List Screen)

FIG. 8 shows the device list screen displayed by the management program 300 in step S418 in FIG. 4B.

As shown in FIG. 8, the paging control 801 is displayed on the device list screen 800. When the paging control 801 is operated by the user, the page transition process is performed to shift the device list screen to a device list page containing information for the maximum display number dsp of devices, as previously described with reference to FIG. 5.

As described in detail above, according to this embodiment, the management program 300 running on the multi-functional device 100 first acquires only IP addresses as the basic information from all the searched devices. Then, it is determined whether each of the searched devices is a display object device whose detail information is to be displayed on the device list screen, and the additional information is acquired only from the devices which are determined as the display object devices.

As a result, it is possible to provide the management program 300 that runs on the multi-functional device and that is able to manage a large number of devices without restricting an amount of information acquired from the management object devices and without restricting the number of the management object devices, while suppressing a consumed storage area to a minimum.

### Second Embodiment

A second embodiment of this invention has the basic construction which is the same as that of the first embodiment (FIGS. 1 to 3), and therefore, only points different from the first embodiment will be described below.

### (Procedures of Screen Display of the Device List)

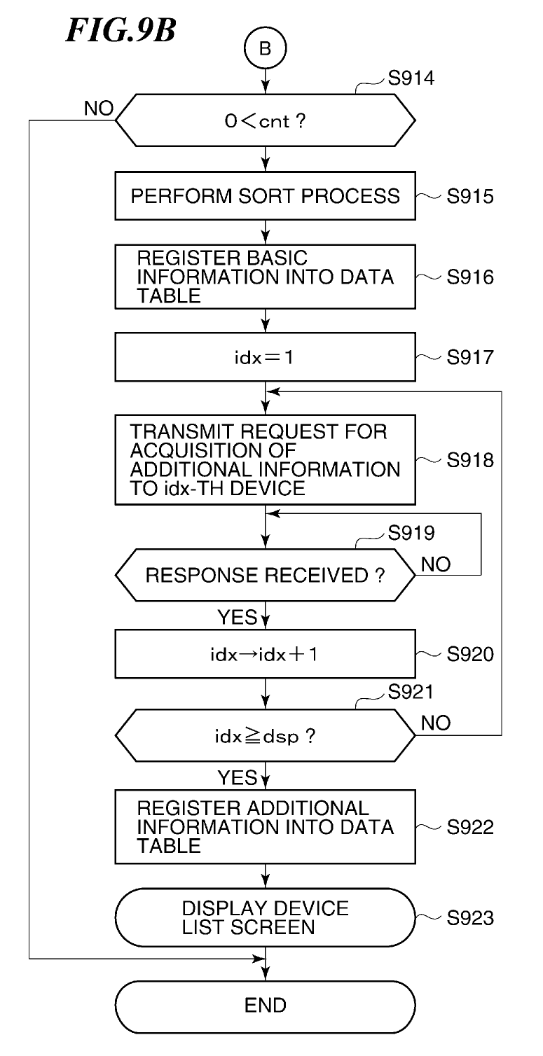

FIGS. 9A and 9B show in flowchart a process performed by the management program 300 running on the multi-functional device 110 according to the second embodiment to search for devices on the network 100 and to display on the device list screen a list of information on the searched devices.

In this process, display on the user interface (UI) and user's input are processed by the device list unit 304 shown in FIG. 3, and search of devices connected to the network 100 is processed by the device search unit 308, the SNMP unit 311, and the TCP/IP unit 313, which are shown in FIG. 3.

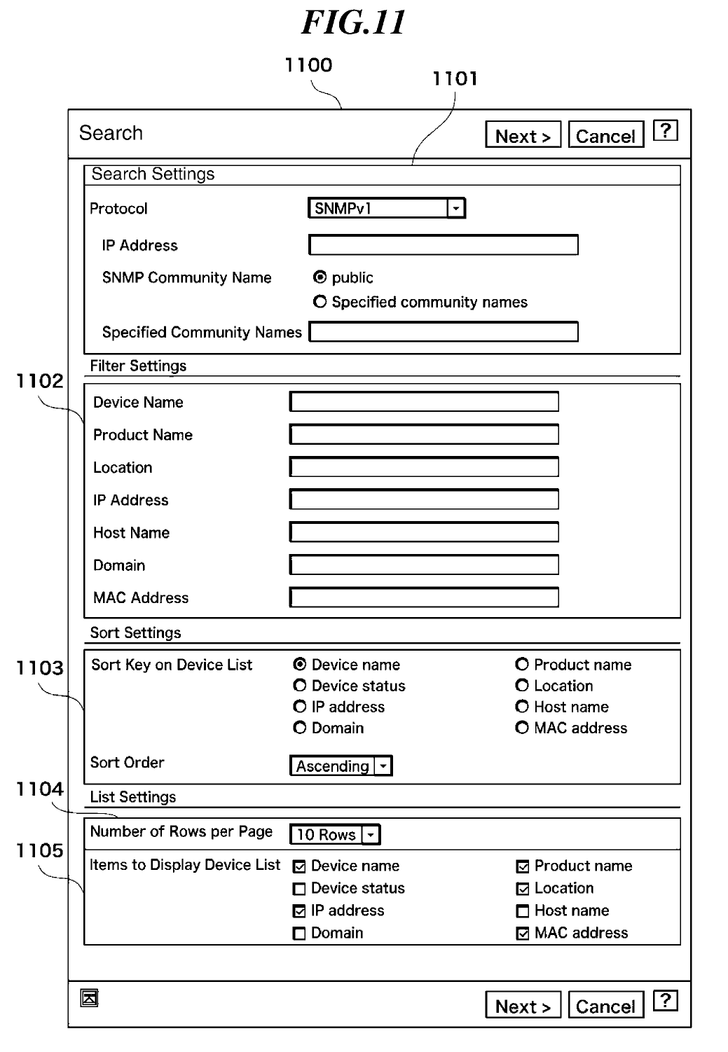

Referring to FIGS. 9A and 9B, the management program 300 displays a search setting screen (shown at 1100 FIG. 11) on the display unit 111a of the operation unit 111 (step S900). When a device search condition is designated by the user on the search setting screen 1100, the management program 300 sets the search condition (step S901 (second setting unit)). Broadcast address, SNMP community name, and the like are set as the search condition since it is assumed in this embodiment that the management program 300 searches for devices by using broadcast search and SNMP protocol.

When a maximum number dsp (i.e., a maximum number of device fields that can be displayed on one page of the device list screen shown at 800 in FIG. 8) is selected by the user on the search setting screen 1100, the management program 300 sets the maximum display number dsp (step S902 (first setting unit)). Next, when display items to be displayed on the device list screen 800 are selected by the user on the search setting screen 1100, the management program 300 sets the selected display items (step S903). In the example shown in FIG. 11, device name, IP address, product name, location, and MAC address are selected as the display items.

When a sort key (device name in FIG. 11) for sorting the device list on the device list screen 800 is selected by the user on the search setting screen 1100, the management program 300 sets the selected sort key (step S904 (first selection unit)). When a sort order (ascending or descending) in which the device list is sorted is selected by the user on the search setting screen 1100, the management program 300 sets the selected sort order (step S905 (second selection unit)).

When a filter condition under which information to be displayed on the device list screen 800 in FIG. 8 is filtered is designated by the user on the search setting screen 1100, the management program 300 sets the selected filter condition (step S906 (third setting unit)). In the next step S907, the management program 300 sets a timer for monitoring a device search process to be started in step S909.

The device search process of this embodiment is comprised of two phases. A first phase of the process is to transmit an SNMP broadcast request to acquire, from each device, its IP address, a parameter corresponding to the sort key selected in step S904, and parameters that define the filter condition set in step S906. A second phase is to acquire, from devices having IP addresses acquired in the first phase, information on the display items selected in step S903, except for the IP addresses and the parameters acquired in the first phase. In step S907, a time period for the first phase of the device search process is set to the timer.

In the next step S908, the management program 300 initializes to zero a count value cnt of a counter that represents the number of devices responding to a broadcast request to be transmitted in step S909. Then, in accordance with the search condition set in step S901, the management program 300 starts the first phase device search process. Specifically, the management program 300 transmits to the devices the broadcast request to request each device to transmit the IP address, the parameter corresponding to the sort key, and the parameters defining the filter condition (step S909 (search unit, fourth acquisition unit, and sixth acquisition unit)).

Next, the management program 300 determines whether the timer set in step S907 has timed out (step S910).

If it is determined that a time-out has not occurred (NO to step S910), the management program 300 determines whether it receives a response from any of the devices on the network in response to the broadcast request (step S911). If the management program 300 does not receive a response, the flow returns to step S910. When receiving a response, the management program 300 refers, in step S912 (filter unit), to the response received from the device in step S911 and determines whether the device conforms to the filter condition set in step S906.

If it is determined that the device does not conform to the filter condition, the flow returns to step S910. If it is determined that the device conforms to the filter condition, the management program 300 increments by one the count value cnt of the counter representing the number of devices each sending back the response and conforming to the filter condition (step S913). Subsequently, the flow returns to step S910.

If it is determined that a time-out has occurred (YES to step S910), the management program 300 determines whether the counter value cnt representing the number of devices detected in the first phase device search process is larger than zero (step S914). If it is determined that the number of devices is not larger than zero (i.e., equal to zero), the present process is completed. If it is determined that the number of devices is larger than zero (i.e., equal to or more than one), the management program 300 sorts, in step S915 (sort unit), a result of search in accordance with the sort condition (sort key and sort order) set in steps S904 and S905.

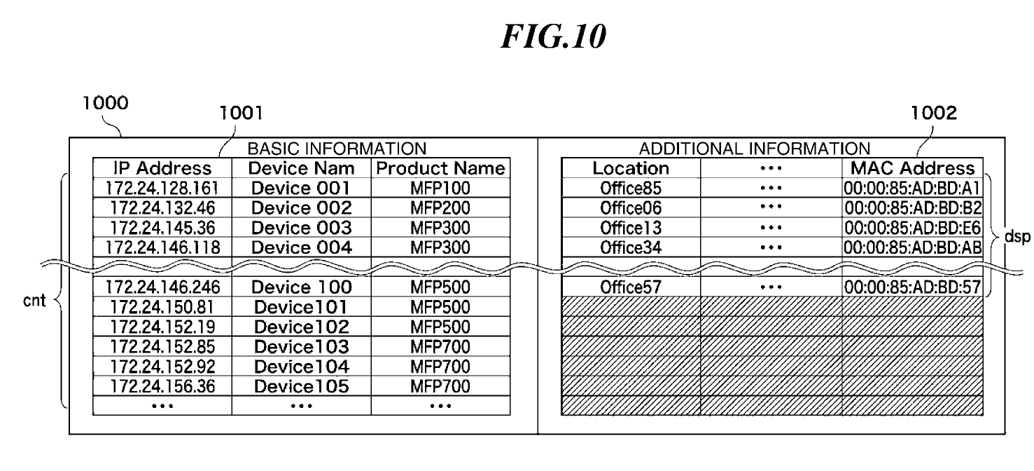

Next, the management program 300 registers the IP addresses, the parameters corresponding to the sort key, and the parameters defining the filter condition, which are acquired in the first phase device search process, into a data table (step S916). The data table is shown at 1000 in FIG. 10. In step S916, basic information list shown at 1001 in FIG. 10 is created.

Next, the management program 300 initializes, to a value of 1, an index idx representing the device from which additional information is to be acquired (step S917), and transmits to the idx-th device a request for acquisition of additional information (step S918 (fifth and seventh acquisition units)). The additional information corresponds to the display items selected in step S903, except for the information acquired in the first phase device search process.

Next, the management program 300 determines whether it receives a response from the idx-th device responding to the additional information acquisition request (step S919). When receiving no response from the idx-th device, the management program 300 waits for reception of a response in step S919. When receiving a response from the idx-th device, the management program 300 increments by one the index idx representing the devices from which the additional information is to be acquired (step S920).

In the next step S921, the management program 300 determines whether the index idx is equal to or larger than the maximum display number dsp set in step S902. If it is determined that the index idx is not equal to nor larger than the maximum display number dsp, the flow returns to step S918.

If it is determined that the index idx is equal to or larger than the maximum display number dsp, the management program 300 determines that the second phase device search process (i.e., the additional information acquisition process) has been completed, and registers the additional information shown at 1002 into the data table in FIG. 10 (step S922). In the next step S923 (display control unit), the management program 300 displays on the operation unit 111a device list screen including information on the first through dsp-th devices based on the data table registered (set) in step S922, whereupon the present process is completed.

### (Construction of Data Table)

FIG. 10 shows the construction of a data table created by the management program 300.

In FIG. 10, reference numeral 1000 denotes the data table, and 1001 denotes a list of basic information registered in step S916 in FIG. 93. In this embodiment, each basic information is comprised of IP address, device name, and product name. The basic information list 1001 shown in FIG. 10 is given in a case where device name is set as the sort key in step S904 and product name is set as the filter condition in step S906 in FIG. 9A.

Reference numeral 1002 denotes a list of the additional information registered in step S916 in FIG. 9B. In this embodiment, each additional information is comprised of desired ones of device status, location, host name, domain, and MAC address.

With the management program 300 of this embodiment, the basic information is acquired from all the searched devices, and the additional information is acquired only from the display object devices whose detail information is to be displayed on the device list screen, as shown in FIG. 10.

### (Search Setting Screen)

FIG. 11 shows a search setting screen displayed by the management program 300.

Referring to FIG. 11, the search setting screen shown at 1100 has a search condition setting field 1101 that serves as the setting unit used for setting the search condition in step S901 in FIG. 9A. A filter condition setting field 1102 is provided as the setting unit used for setting the filter condition in step S906. A sort condition setting field 1103 is provided as the setting unit used for setting the sort condition (sort key and sort order) in steps S904 and S905.

A maximum display number setting field 1104 is provided as the setting unit used in step S902 to select the number of device fields (the number of rows) that can be displayed on one page of the device list screen. A display item selecting field 1105 is provided as a selecting unit used in step S903 to select display items to be displayed on the device list screen. In the example shown in FIG. 11, it is possible to select desired display items from among device name, product name, device status, location, IP address, host name, domain, and MAC address.

As described in detail above, according to this embodiment, the management program 300 running on the multi-functional device 110 first acquires only the basic information from all the searched devices. Based on the acquired basic information that includes IP addresses, sort parameters, and parameters defining the filter condition, the sorting and filtering processes are performed. Then, it is determined whether each of the searched device is a display object device whose detail information is to be displayed on the device list screen, and the additional information is acquired only from the devices which are determined as the display object devices.

As a result, it is possible to provide the management program that runs on the multi-functional device and that is able to manage a large number of devices without restricting an amount of information acquired from the management object devices and without restricting the number of the management object devices, while suppressing a consumed storage area to a minimum, and able to permit the user to easily select desired devices.

### Other Embodiments

Aspects of the present invention can also be: realized by a computer of a system or apparatus (or devices such as a CPU or MPU) that reads out and executes a program recorded on a memory device to perform the functions of the above-described embodiments, and by a method, the steps of which are performed by a computer of, a system or apparatus by, for example, reading out and executing a program recorded on a memory device to perform the functions of the above-described embodiments. For this purpose, the program is provided to the computer for example via network or from a recording medium of various types serving as the memory device, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-138238, filed Jun. 9, 2009, which is hereby incorporated by reference herein in its entirety.

What is claimed is:

1. A device management apparatus able to communicate with a plurality of devices via a network, comprising:
a first setting unit configured to set a number of display object devices whose information can be displayed on a device list;
a search unit configured to search for devices via the network;
a first acquisition unit configured to acquire basic information for device identification from the devices searched by said search unit;
a second acquisition unit configured to acquire additional information from the display object devices; and
a display control unit configured to display the device list on a display unit based on the basic information acquired by said first acquisition unit and the additional information acquired by said second acquisition unit.

2. The device management apparatus according to claim 1, further including:
a discard unit configured, in a case where the device list to be displayed on the display unit is switched from a currently displayed page to a next page, to discard additional information contained in the currently displayed page of the device list; and
a third acquisition unit configured, in a case where the next page of the device list is displayed, to acquire additional information from devices that become next display object devices,
wherein said display control unit displays on the display unit the device list that includes the additional information acquired by said third acquisition unit.

3. The device management apparatus according to claim 1, further including:
a first selection unit configured to select a sort key for sorting the device list;
a second selection unit configured to select a sort order in which the device list is sorted by using the sort key selected by said first selection unit;
a fourth acquisition unit configured to acquire, from the devices searched by said search unit, information corresponding to the sort key selected by said first selection unit;
a sort unit configured to sort the information on the devices searched by said search unit according to a sort key corresponding to the information acquired by said fourth acquisition unit and the sort order selected by said second selection unit; and
a fifth acquisition unit configured to acquire additional information, other than the information corresponding to the sort key, from the display object devices in accordance with a result of sorting by said sort unit,
wherein said display control unit displays on the display unit the device list based on the additional information acquired by said fifth acquisition unit.

4. The device management apparatus according to claim 1, further including:
a second setting unit configured to set a filtering condition under which display information to be displayed on the device list is filtered;
a sixth acquisition unit configured to acquire, from the devices searched by said search unit, a parameter that defines the filter condition set by said second setting unit;
a filter unit configured to perform filtering according to the filter condition by referring to the parameter acquired by said sixth acquisition unit; and
a seventh acquisition unit configured, based on a result of the filtering performed by said filter unit, to acquire additional information other than the parameter defining the filter condition from the display object devices,
wherein said display control unit displays the device list on the display unit based on the additional information acquired by said the seventh acquisition unit.

5. The device management apparatus according to claim 1, wherein the basic information includes an IP address, and the additional information includes any of a device name, a product name, installation location information, and a MAC address.

6. A control method for a device management apparatus able to communicate with a plurality of devices via a network, comprising:
a first setting step of setting a number of display object devices whose information can be displayed on a device list;
a search step of searching for devices via the network;
a first acquisition step of acquiring basic information for device identification from the devices searched in said search step;
a second acquisition step of acquiring additional information from the display object devices; and
a display control step of displaying the device list on a display unit based on the basic information acquired in said first acquisition step and the additional information acquired in said second acquisition step.

7. A non-transitory computer-readable storage medium storing a program for causing a computer to execute the control program as set fourth in claim 6.
